(19) United States
(12) Patent Application Publication
(10) Pub. No.: US 2023/0197965 A1
(43) Pub. Date: Jun. 22, 2023

(54) ELECTRODE BINDER AND SLURRY COMPOSITIONS FOR LITHIUM ION ELECTRICAL STORAGE DEVICES

(71) Applicant: PPG Industries Ohio, Inc., Cleveland, OH (US)

(72) Inventors: Pengfei Zhan, Pittsburgh, PA (US); Hongying Zhou, Allison Park, PA (US); Stuart D. Hellring, Pittsburgh, PA (US); Fanghui Wu, Pittsburgh, PA (US); Weimin Wang, San Mateo, CA (US)

(73) Assignee: PPG Industries Ohio, Inc., Cleveland, OH (US)

(21) Appl. No.: 17/996,243

(22) PCT Filed: Feb. 16, 2021
(86) PCT No.: PCT/US2021/018259

§ 371 Date: Oct. 14, 2022

Related U.S. Application Data
(60) Provisional application No. 63/011,395, filed on Apr. 17, 2020.

(51) Int. Cl. H01M 4/62; H01M 4/04

(52) U.S. Cl. CPC H01M 4/623; H01M 4/0404

(57) ABSTRACT

The present invention provides a binder composition comprising (a) a primary fluoropolymer; and (b) a secondary fluoropolymer different from the primary fluoropolymer, the secondary fluoropolymer comprising at least one perfluoropolyether segment, at least one non-fluorinated segment, and a linking group that links the perfluoropolyether segment and the non-fluorinated segment. The invention further provides slurry compositions, electrodes, and electrical storage devices.

### NOTICE OF GOVERNMENT SUPPORT

This invention was made with Government support under Government Contract No. DE-EE0006250 awarded by the Department of Energy. The United States Government has certain rights in this invention.

### FIELD OF THE INVENTION

The invention relates to fluoropolymer binder and slurry compositions that could be used in manufacturing electrodes for use in electrical storage devices, such as batteries.

### BACKGROUND OF THE INVENTION

There is a trend in the electronics industry to produce smaller devices, powered by smaller and lighter batteries. Batteries with a negative electrode–-such as a carbonaceous material, and a positive electrode–-such as lithium metal oxides can provide relatively high power and low weight.

Fluoropolymers such as polyvinylidene fluoride, because of their excellent electrochemical resistance, have been found to be useful binders for forming electrodes to be used in electrical storage devices. Typically, the fluoropolymer is dissolved in an organic solvent and the electrode material is combined with the PVDF solution to form a slurry that is applied to a metal foil or mesh to form the electrode. The role of the organic solvent is to dissolve fluoropolymer in order to provide good adhesion between the electrode material particles and the metal foil or mesh upon evaporation of the organic solvent. Currently, the organic solvent of choice is N-methyl-2-pyrrolidone (NMP). PVDF binders dissolved in NMP provide superior adhesion and an interconnectivity of all the active ingredients in the electrode composition. The bound ingredients are able to tolerate large volume expansion and contraction during charge and discharge cycles without losing interconnectivity within the electrodes. Interconnectivity of the active ingredients in an electrode is extremely important in battery performance, especially during charging and discharging cycles, as electrons must move through the electrode, and lithium ion mobility requires interconnectivity within the electrode between particles. Unfortunately, NMP is a toxic material and presents health and environmental issues.

Alternative technologies to NMP have been developed. However, for the alternative technologies to be useful they must be compatible with current manufacturing practices and provide desired properties of the intermediate and final products. Some common criteria include: a) stability of the fluoropolymer dispersion having sufficient shelf-life, b) stability of the slurry after admixing the electrochemically active and/or electroconductive powders with the dispersion, c) appropriate viscosity of the slurry to facilitate good application properties, d) sufficient interconnectivity within the electrode, and e) sufficient durability of the binder for the resulting electrode coating to the electrolyte in the battery.

It is therefore an object of the present invention to provide stable fluoropolymer binder composition dispersions using alternatives to N-methyl-2-pyrrolidone that meet these criteria. The binder compositions may be used in preparing electrode-forming slurry compositions for producing high quality electrodes having interconnectivity and durability for use in batteries and other electrical storage devices.

### SUMMARY OF THE INVENTION

The present invention provides a binder composition comprising (a) a primary fluoropolymer; and (b) a secondary fluoropolymer different from the primary fluoropolymer, the secondary fluoropolymer comprising at least one perfluoropolyether segment, at least one non-fluorinated segment, and a linking group that links the perfluoropolyether segment and the non-fluorinated segment.

The present invention also provides a slurry composition comprising a binder composition comprising (a) a primary fluoropolymer; and (b) a secondary fluoropolymer different from the primary fluoropolymer, the secondary fluoropolymer comprising at least one perfluoropolyether segment, at least one non-fluorinated segment, and a linking group that links the perfluoropolyether segment and the non-fluorinated segment; an electrochemically active material; and a liquid medium.

The present invention further provides a slurry composition comprising a binder composition comprising (a) a primary fluoropolymer; and (b) a secondary fluoropolymer different from the primary fluoropolymer, the secondary fluoropolymer comprising at least one perfluoropolyether segment, at least one non-fluorinated segment, and a linking group that links the perfluoropolyether segment and the non-fluorinated segment; an electrically conductive agent; and a liquid medium.

The present invention also provides an electrode comprising (a) an electrical current collector; and (b) a film formed on the electrical current collector, wherein the film is deposited from a slurry composition comprising a binder composition comprising (a) a primary fluoropolymer; and (b) a secondary fluoropolymer different from the primary fluoropolymer, the secondary fluoropolymer comprising at least one perfluoropolyether segment, at least one non-fluorinated segment, and a linking group that links the perfluoropolyether segment and the non-fluorinated segment; an electrochemically active material; and a liquid medium.

The present invention further provides an electrical storage device comprising (a) an electrode of the present invention; (b) a counter electrode; and (c) an electrolyte.

### DETAILED DESCRIPTION

The present invention is directed to a binder composition comprising (a) a primary fluoropolymer; and (b) a secondary fluoropolymer different from the primary fluoropolymer, the secondary fluoropolymer comprising at least one perfluoropolyether segment, at least one non-fluorinated segment, and a linking group that links the perfluoropolyether segment and the non-fluorinated segment.

The binder composition of the present invention may be used in formulating a slurry composition that comprises the binder composition in addition to other optional components. The components of the binder composition may serve as the binder for the slurry composition.

According to the present invention, the binder composition comprises a primary fluoropolymer. The primary fluoropolymer may comprise a (co)polymer comprising the residue of vinylidene fluoride. A non-limiting example of a (co)polymer comprising the residue of vinylidene fluoride is a polyvinylidene fluoride polymer (PVDF). As used herein, the “polyvinylidene fluoride polymer” includes homopolymers, copolymers, such as binary copolymers, and terpolymers, including high molecular weight homopolymers, copolymers, and terpolymers. Such (co)polymers include those containing at least 50 mole percent, such as at least 75 mole %, and at least 80 mole %, and at least 85 mole % of the residue of vinylidene fluoride (also known as vinylidene difluoride). The vinylidene fluoride monomer may be copolymerized with at least one comonomer selected from the group consisting of tetrafluoroethylene, trifluoroethylene, chlorotrifluoroethylene, hexafluoropropene, vinyl fluoride, pentafluoropropene, tetrafluoropropene, perfluoromethyl vinyl ether, perfluoropropyl vinyl ether and any other monomer that would readily copolymerize with vinylidene fluoride in order to produce the primary fluoropolymer of the present invention. The primary fluoropolymer may also comprise a PVDF homopolymer.

The primary fluoropolymer may comprise a high molecular weight PVDF having a weight average molecular weight of at least 50,000 g/mol, such as at least 100,000 g/mol, and may range from 50,000 g/mol to 1,500,000 g/mol, such as 100,000 g/mol to 1,000 ,000 g/mol. PVDF is commercially available, e.g., from Arkema under the trademark KYNAR from Solvay under the trademark HYLAR, and from Inner Mongolia 3F Wanhao Fluorochemical Co., Ltd.

The primary fluoropolymer may comprise a nanoparticle. As used herein, the term “nanoparticle” refers to particles having a particle size of less than 1,000 nm. The primary fluoropolymer may have a particle size of at least 50 nm, such as at least 100 nm, such as at least 250 nm, such as at least 300 nm, and of no more than 900 nm, such as no more than 600 nm, such as no more than 450 nm, such as no more than 400 nm, such as no more than 300 nm, such as no more than 200 nm. The primary fluoropolymer nanoparticles may have a particle size of 50 nm to 900 nm, such as 100 nm to 600 nm, such as 250 nm to 450 nm, such as 300 nm to 400 nm, such as 100 nm to 400 nm, such as 100 nm to 300 nm, such as 100 nm to 200 nm. As used herein, the term “particle size” refers to average diameter of the primary fluoropolymer particles. The particle size referred to in the present disclosure was determined by the following procedure: A sample was prepared by dispersing the primary fluoropolymer onto a segment of carbon tape that was attached to an aluminum scanning electron microscope (SEM) stub. Excess particles were blown off the carbon tape with compressed air. The sample was then sputter coated with Au/Pd for 20 seconds and was then analyzed in a Quanta 250 FEG SEM (field emission gun scanning electron microscope) under high vacuum. The accelerating voltage was set to 20.00 kV and the spot size was set to 3.0. Images were collected from three different areas on the prepared sample, and ImageJ software was used to measure the diameter of 10 primary fluoropolymer particles from each area for a total of 30 particle size measurements that were averaged together to determine the average particle size.

The primary fluoropolymer may be present in the binder in an amount of at least 30% by weight, such as at least 40% by weight, such as at least 50% by weight, such as at least 65% by weight, such as at least 70% by weight, such as at least 80% by weight, such as at least 85% by weight, such as at least 90% by wight, such as at least 95% by weight, such as at 98% by weight, based on the total weight of the binder solids. The primary fluoropolymer may be present in an amount of no more than 98% by weight, such as no more than 95% by weight, such as no more than 90% by weight, such as no more than 85% by weight, such as no more than 70% by weight, such as no more than 60% by weight, such as no more than 50% by weight, based on the total weight of the binder solids. The primary fluoropolymer may be present in the binder in amounts of 30% to 98% by weight, such as 30% to 95% by weight, such as 30% to 90% by weight, such as 30% to 85% by weight, such as 30% to 70% by weight, such as 30% to 60% by weight, such as 30% to 50% by weight, such as 40% to 98% by weight, such as 40% to 95% by weight, such as 40% to 90% by weight, such as 40% to 85% by weight, such as 40% to 70% by weight, such as 40% to 60% by weight, such as 40% to 50% by weight, such as 50% to 98% by weight, such as 50% to 95% by weight, such as 50% to 90% by weight, such as 50% to 85% by weight, such as 50% to 70% by weight, such as 50% to 60% by weight, such as 65% to 98% by weight, such as 65% to 95% by weight, such as 65% to 90% by weight, such as 65% to 85% by weight, such as 65% to 70% by weight, such as 70% to 98% by weight, such as 70% to 95% by weight, such as 70% to 90% by weight, such as 70% to 85% by weight, such as 80% to 98% by weight, such as 80% to 95% by weight, such as 80% to 90% by weight, such as 80% to 85% by weight, such as 85% to 98% by weight, such as 85% to 95% by weight, such as 85% to 90% by weight, such as 90% to 98% by weight, such as 90% to 95% by weight, such as 95% to 98% by weight, based on the total weight of the binder solids. The primary fluoropolymer may be solubilized or dispersed in the organic medium.

According to the present invention, the binder composition may comprise a secondary fluoropolymer different from the primary fluoropolymer, the secondary fluoropolymer comprising at least one perfluoropolyether segment, at least one non-fluorinated segment, and a linking group that links the perfluoropolyether segment and the non-fluorinated segment.

As used herein, the term “perfluoropolyether segment” refers to a segment of a compound or polymer having repeating units of “—C(F)(F)—C(F)(F)—O—”. The perfluoropolyether segment may comprise a segment having the structure R—O—[C(F)(F)—C(F)(F)—O—]ₙR, wherein R is a substituted or unsubstituted alkylene, arylene, cycloalkylene, or cycloarylene group and n is an integer of 1 or more, such as 1 to 500. The perfluoropolyether segment may be present in the secondary fluoropolymer as the residue of a perfluoropolyether having reactive functional groups. For example, the perfluoropolyether may comprise active hydrogen functional groups (as that term is defined herein) such as hydroxyl groups, primary or secondary amino groups, carboxylic acid groups, and/or thiol groups, and/or may comprise functional groups reactive with active hydrogen functional groups such as isocyanate or epoxide functional groups, and these functional groups may react with a functional group of another reactant, such as a different perfluropolyether or non-fluorinated compound, in forming the secondary fluoropolymer. The perfluoropolyether may be a mono-functional, di-functional, tri-functional, tetra-functional or higher functional perfluoropolyether.

As used herein, the term “non-fluorinated segment” refers to an organic segment that is free of fluorine atoms. The non-fluorinated segment may comprise a substituted or unsubstituted alkyl, alkylene, cycloalkyl, cycloalkylene, aryl, arylene, cycloaryl, or cycloarylene group. The non-fluorinated segment may comprise functional groups or may be free of functional groups. The non-fluorinated segment may be present in the secondary fluoropolymer as the residue of a non-fluorinated compound having reactive functional groups. For example, the non-fluorinated compound may comprise active hydrogen functional groups such as hydroxyl groups, primary or secondary amino groups, carboxylic acid groups, and/or thiol groups, and/or may comprise functional groups reactive with active hydrogen functional groups such as isocyanate or epoxide functional groups, and these functional groups may react with a functional group of another reactant in forming the secondary fluoropolymer. The functional groups of the non-fluorinated compound may be selected so as to be reactive with the functional groups of the perfluoropolyether.

The non-fluorinated segment of the secondary fluoropolymer is not limited and may comprise the residue of any suitable non-fluorinated compound. The non-fluorinated compound may comprise a mono-functional, di-functional, tri-functional, tetra-functional or higher functional compound that is reactive with the perfluoropolyether. For example, the non-fluorinated compound may comprise a mono- or polyisocyanate compound, such as a diisocyanate, tri-isocyanate, or higher functional isocyanate.

As used herein, the term “linking group” refers to a moiety that is formed between two reactive compounds resulting in a covalent bond that links the two compounds together in forming the secondary fluoropolymer. The linking group is not limited and may comprise any moiety that could be formed by the reaction of the functional groups of the constituent compounds that form the secondary fluoropolymer. For example, the linking group may comprise any chemical moiety resulting from the reaction of an active hydrogen functional group and a functional group reactive with active hydrogen functional groups. Non-limiting examples of linking groups include urethane groups, urea groups, thiocarbamate groups, ether groups, thioether groups, among others.

Optionally, the secondary fluoropolymer may further comprise a polyfluorinated polyether segment. As used herein, the term “polyfluorinated polyether segment” refers to a compound or a polymer that has a carbon chain connected to the ether oxygen that has at least two fluorine atom substitutions for hydrogen but is not fully saturated with fluorine atoms. One non-limiting of example this structure include FEVE polymers. FEVE polymers are comprised of fluoroethylene (FE) and vinyl ethers (VE) and are commercially supplied by AGC Chemicals under the product name LUMIFLON.

As discussed above, the secondary fluoropolymer comprises at least one perfluoropolyether segment, at least one non-fluorinated segment, and a linking group that links the perfluoropolyether segment and the non-fluorinated segment. The ratio of non-fluorinated segments to perfluoropolyether segments may be at least 0.5:1, such as at least 1:1, such as at least 1.5:1, such as at least 2:1, such as at least 2.5: 1, such as at least 3:1, such as at least 4:1, such as at least 5:1, such as at least 100:1. The ratio of non-fluorinated segments to perfluoropolyether segments may be no more than 100:1, such as no more than 5:1, such as no more than 4:1, such as no more than 3:1, such as no more than 2.5:1, such as no more than 2:1, such as no more than 1.5:1, such as no more than 1:1. The ratio of non-fluorinated segments to perfluoropolyether segments may be 0.5: 1 to 100:1, such as 0.5: 1 to 5:1, such as 0.5: 1 to 4:1, such as 0.5:1 to 3:1, such as 0.5:1 to 2.5:1, such as 0.5:1 to 2:1, such as 0.5:1 to 1.5:1, such as 0.5: 1 to 1:1, such as 1:1 to 100:1, such as 1:1 to 5:1, such as 1:1 to 4:1, such as 1:1 to 3:1, such as 1:1 to 2.5:1, such as 1:1 to 2:1, such as 1:1 to 1.5:1, such as such as 1.5:1 to 100:1, such as 1.5:1 to 5:1, such as 1.5:1 to 4:1, such as 1.5:1 to 3:1, such as 1.5:1 to 2.5:1, such as 1.5:1 to 2:1, such as 2:1 to 100:1, such as 2:1 to 5:1, such as 2:1 to 4:1, such as 2:1 to 3:1, such as 2:1 to 2.5:1, such as 2.5:1 to 100:1, such as 2.5:1 to 5:1, such as 2.5:1 to 4:1, such as 2.5:1 to 3:1, such as 3:1 to 100:1, such as 3:1 to 5:1, such as 3:1 to 4:1, such as 4:1 to 100:1, such as 4:1 to 5:1, such as 5:1 to 100:1. A linking group would be present between the segments of the secondary fluoropolymer.

The secondary fluoropolymer also comprises the residue of at least one perfluoropolyether and the residue of at least one non-fluorinated compound. The ratio of the residue of non-fluorinated compound to perfluoropolyether may be the same as discussed above with respect to the ratio of non-fluorinated segments to perfluoropolyether segments. For example, the ratio of residues of the non-fluorinated compound to perfluoropolyether may be 0.5:1 to 100:1, such as 0.5:1 to 5:1, such as 0.5:1 to 4:1, such as 0.5:1 to 3:1, such as 0.5:1 to 2.5:1, such as 0.5:1 to 2:1, such as 0.5:1 to 1.5:1, such as 0.5:1 to 1:1, such as 1:1 to 100:1, such as 1:1 to 5:1, such as 1:1 to 4:1, such as 1:1 to 3:1, such as 1:1 to 2.5:1, such as 1:1 to 2:1, such as 1:1 to 1.5:1, such as such as 1.5:1 to 100:1, such as 1.5:1 to 5:1, such as 1.5:1 to 4:1, such as 1.5:1 to 3:1, such as 1.5:1 to 2.5:1, such as 1.5:1 to 2:1, such as 2:1 to 100:1, such as 2:1 to 5:1, such as 2:1 to 4:1, such as 2:1 to 3:1, such as 2:1 to 2.5:1, such as 2.5:1 to 100:1, such as 2.5:1 to 5:1, such as 2.5:1 to 4:1, such as 2.5:1 to 3:1, such as 3:1 to 100:1, such as 3:1 to 5:1, such as 3:1 to 4:1, such as 4:1 to 100:1, such as 4:1 to 5:1, such as 5:1 to 100:1. A linking group would be present between each residue of the non-fluorinated compound or residue of the perfluoropolyether of the secondary fluoropolymer other than terminal residues.

The secondary fluoropolymer may have a weight average molecular weight of at least 100 g/mol, such as at least 500 g/mol, such as at least 1,000 g/mol, such as at least 1,200 g/mol. The secondary fluoropolymer may have a weight average molecular weight of no more than 10,000 g/mol, such as no more than 9,000 g/mol, such as no more than 7,500 g/mol, such as no more than 6,000 g/mol, such as no more than 3,000 g/mol, such as no more than 1,800 g/mol. The secondary fluoropolymer may have a weight average molecular weight of 100 to 10,000 g/mol, such as 100 to 9,000 g/mol, such as 100 to 7,500 g/mol, such as 100 to 6,000 g/mol, such as 500 to 10,000 g/mol, such as 500 to 9,000 g/mol, such as 500 to 7,500 g/mol, such as 500 to 6,000 g/mol, such as 500 to 3,000 g/mol, such as 500 to 1,800 g/mol, such as 1,000 to 10,000 g/mol, such as 1,000 to 9,000 g/mol, such as 1,000 to 7,500 g/mol, such as 1,000 to 6,000 g/mol, such as 1,000 to 3,000 g/mol, such as 1,000 to 1,800 g/mol, such as 1,200 to 10,000 g/mol, such as 1,200 to 9,000 g/mol, such as 1,200 to 7,500 g/mol, such as 1,200 to 6,000 g/mol, such as 1,200 to 3,000 g/mol, such as 1,200 to 1,800 g/mol.

A non-limiting example of the secondary fluoropolymer is according to the structure:

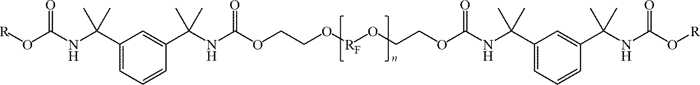

wherein each R independently comprises an alkyl, aryl, cycloalkyl, or cycloaryl group, such as a C₁ to C₆, alkyl, aryl, cycloalkyl, or cycloaryl group, n is an integer from 1 to 500, such as 1 to 200, such as 1 to 100, such as 1 to 84, such as 5-30, such as 8-20, such as 9-16, and each R_{F} is independently (CF₂)ₘ wherein m is 1 or 2. The R group may comprise, for example, 1 to 18 carbons, such as 1 to 10 carbons, such as 1 to 8 carbons, such as 1 to 6 carbons, such as 1 to 3 carbons, or more.

Another non-limiting example of the secondary fluoropolymer is according to the structure:

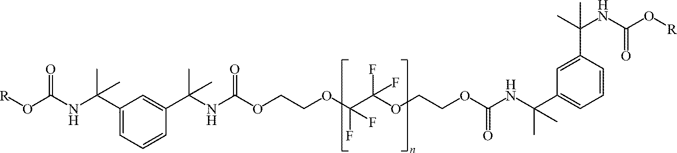

wherein each R independently comprises an alkyl, aryl, cycloalkyl, or cycloaryl group, such as a C₁ to C₆, alkyl, aryl, cycloalkyl, or cycloaryl group, and n is an integer from 1 to 500, such as 1 to 200, such as 1 to 100, such as 1 to 84, such as 5-30, such as 8-20, such as 9-16.

The non-limiting example of the secondary fluoropolymer may be made by the reaction synthesis illustrated below. For example, a di-hydroxyl-functional perfluoropolyether may be reacted with two equivalents of a diisocyanate to produce a polymer having a central perfluoropolyether segment (residue of the di-hydroxyl-functional perfluoropolyether) that is linked by urethane linking groups at each by to the two di-isocyanate segments (residue of the diisocyanate) resulting in two terminal isocyanato functional groups. The isocyanato functional groups may then be reacted with an alcohol, such as butanol, to cap the isocyanato functional groups.

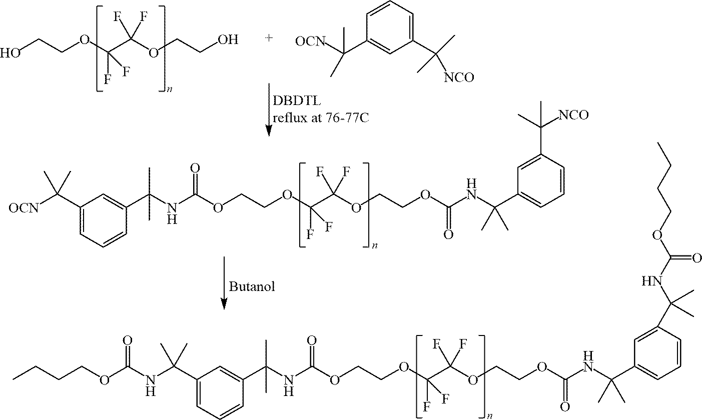

A second non-limiting example of a reaction synthesis to produce a secondary fluoropolymer is illustrated below. For example, a diisocyanate may be reacted with two equivalents of a di-hydroxyl-functional perfluoropolyether to produce a polymer having a central diisocyanate segment (residue of the di-hydroxyl-functional perfluoropolyether) that is linked by urethane linking groups at each by to the two perfluoropolyether segments (residue of the di-hydroxyl-functional perfluoropolyether) resulting in two terminal hydroxyl functional groups and a hydroxyl functional secondary fluoropolymer.

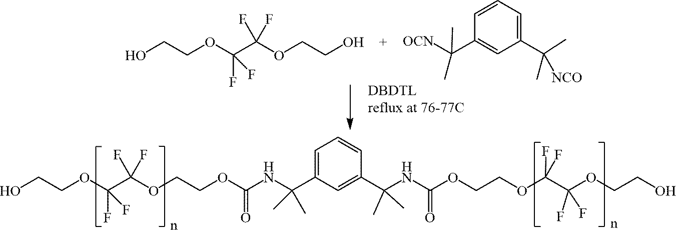

The secondary fluoropolymer may be present in the binder in an amount of at least 0.1% by weight, such as at least 0.5% by weight, such as at least 1% by weight, such as at least 2% by weight, such as at least 5% by weight, such as at least 7.5% by weight, such as at least 10% by weight, such as at least 15% by weight, such as at least 20% by weight, such as at least 25% by weight, such as at least 30% by weight, such as at least 35% by weight, based on the total weight of the binder solids. The secondary fluoropolymer may be present in the binder in an amount of not more than 35% by weight, such as no more than 25% by weight, such as no more than 20% by weight, such as no more than 15% by weight, such as not more than 10% by weight, such as no more than 7.5% by weight, such as no more than 5% by weight, such as no more than 3% by weight, such as no more than 2% by weight, such as no more than 1% by weight, based on the total weight of the binder solids. The secondary fluoropolymer may be present in the binder in amounts of 0.1% to 35% by weight, such as 0.1% to 25% by weight, such as 0.1% to 20% by weight, such as 0.1% to 15% by weight, such as 0.1% to 10% by weight, such as 0.1% to 7.5% by weight, such as 0.1% to 5% by weight, such as 0.1% to 3% by weight, such as 0.1% to 2% by weight, such as 0.1% to 1% by weight, such as 0.5% to 35% by weight, such as 0.5% to 25% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 3% by weight, such as 0.5% to 2% by weight, such as 0.5% to 1% by weight, such as 1% to 35% by weight, such as 1% to 25% by weight, such as 1% to 20% by weight, such as 1% to 15% by weight, such as 1% to 10% by weight, such as 1% to 7.5% by weight, such as 1% to 5% by weight, such as 1% to 3% by weight, such as 1% to 2% by weight, such as 2% to 35% by weight, such as 2% to 25% by weight, such as 2% to 20% by weight, such as 2% to 15% by weight, such as 2% to 10% by weight, such as 2% to 7.5% by weight, such as 2% to 5% by weight, such as 2% to 3% by weight, such as such as 5% to 35% by weight, such as 5% to 25% by weight, such as 5% to 20% by weight, such as 5% to 15% by weight, such as 5% to 10% by weight, such as 5% to 7.5% by weight, such as 7.5% to 35% by weight, such as 7.5% to 25% by weight, such as 7.5% to 20% by weight, such as 7.5% to 15% by weight, such as 7.5% to 10% by weight, such as 10% to 35% by weight, such as 10% to 25% by weight, such as 15% to 35% by weight, such as 15% to 25% by weight, such as 20% to 35% by weight, such as 20% to 25% by weight, such as 25% to 35% by weight, such as 30% to 35% by weight, based on the total weight of the binder solids. The secondary fluoropolymer may be solubilized or dispersed in the organic medium.

The ratio of primary fluoropolymer to secondary fluoropolymer may be at least 5:1, such as at least 10:1, such as at least 20:1, such as at least 25:1, such at least 30:1, such as at least 35:1, such as at least 40:1, such as at least 50:1, such as at least 55:1. The ratio of primary fluoropolymer to secondary fluoropolymer may be no more than 65:1, such as no more than 60:1, such as no more than 55:1, such as no more than 50:1, such as no more than 40:1, such as no more than 35:1, such as no more than 30:1, such as no more than 25:1, such as no more than 20:1, such as no more than 15:1, such as no more than 10:1. The ratio of primary fluoropolymer to secondary fluoropolymer may be from 5:1 to 65:1, such as from 5:1, to 60:1, such as from 5:1 to 55:1, such as from 5:1 to 50:1, such as from 5:1 to 40:1, such as from 5:1 to 35:1, such as from 5:1 to 30:1, such as from 5:1 to 25:1, such as from 5:1 to 20:1, such as from 5:1 to 15:1, such as from 5:1 to 10:1, such as from 10:1 to 65:1, such as from 10:1, to 60:1, such as from 10:1 to 55:1, such as from 10:1 to 50:1, such as from 10:1 to 40:1, such as from 10:1 to 35:1, such as from 10:1 to 30:1, such as from 10:1 to 25:1, such as from 10:1 to 20:1, such as from 10:1 to 15:1, such as from 20:1 to 65:1, such as from 20:1, to 60:1, such as from 20:1 to 55:1, such as from 20:1 to 50:1, such as from 20:1 to 40:1, such as from 20:1 to 35:1, such as from 20:1 to 30:1, such as from 20:1 to 25:1, such as from 25:1 to 65:1, such as from 25:1, to 60:1, such as from 25:1 to 55:1, such as from 25:1 to 50:1, such as from 25:1 to 40:1, such as from 25:1 to 35:1, such as from 25:1 to 30:1, such as from 25:1 to 25:1, such as from 25:1 to 20:1, such as from 25:1 to 15:1, such as from 25:1 to 10:1, such as 30:1 to 65:1, such as from 30:1, to 60:1, such as from 30:1 to 55:1, such as from 30:1 to 50:1, such as from 30:1 to 40:1, such as from 30:1 to 35:1, such as from 35:1 to 65:1, such as from 35:1, to 60:1, such as from 35:1 to 55:1, such as from 35:1 to 50:1, such as from 35:1 to 40:1, such as from 40:1 to 65:1, such as from 40:1, to 60:1, such as from 40:1 to 55:1, such as from 40:1 to 50:1, such as from 50:1 to 65:1, such as from 50:1, to 60:1, such as from 55:1 to 65:1, such as from 55:1, to 60:1.

According to the present invention, the binder composition and/or slurry composition may comprise a liquid medium. The liquid medium may comprise an organic medium. As used herein, the term “organic medium” refers to a liquid medium comprising less than 50% by weight water, based on the total weight of the organic medium. Such organic mediums may comprise less than 40% by weight water, or less than 30% by weight water, or less than 20% by weight water, or less than 10% by weight water, or less than 5% by weight water, or less than 1% by weight water, or less than 0.1% by weight water, based on the total weight of the organic medium, or may be free of water. Organic solvent(s) comprise more than 50 % by weight of the organic medium, such as at least 70% by weight, such as at least 80% by weight, such as at least 90% by weight, such as at least 95% by weight, such as at least 99% by weight, such as at least 99.9% by weight, such as 100% by weight, based on the total weight of the organic medium. The organic solvent(s) may comprise 50.1% to 100% by weight, such as 70% to 100% by weight, such as 80% to 100% by weight, such as 90% to 100% by weight, such as 95% to 100% by weight, such as 99% to 100% by weight, such as 99.9% to 100% by weight, based on the total weight of the organic medium.

The organic medium optionally may have an evaporation rate of less than 10 g/min m², at the dissolution temperature of the primary fluoropolymer dispersed in the organic medium. Evaporation rates may be measured using ASTM D3539 (1996). According to the present invention, the dissolution temperature of the primary fluoropolymer dispersed in the organic medium may be determined by measuring complex viscosity of the mixture as a function of temperature. This technique may be applied to fluoropolymers (in addition to other types of polymer) mixed in an organic medium where the total mass of non-volatile solids content of such mixtures is from 44% to 46%, such as 45% of the total mass of the mixture. Complex viscosity may be measured with an Anton-Paar MCR301 rheometer using a 50 millimeter cone and temperature-controlled plate. The complex viscosity of fluoropolymer mixtures is measured over a temperature range from 20° C. to at least 75° C. with a temperature ramp rate of 10° C. per minute, an oscillatory frequency of 1 Hz, and a stress amplitude setpoint of 90 Pa. The dissolution of primary fluoropolymer in the organic medium is indicated by a sharp increase in the complex viscosity as temperature increased. The dissolution temperature is defined as the temperature at which the rate of change in viscosity with increasing temperature is highest and is calculated by determining the temperature at which the first derivative with respect to temperature of the Log₁₀ of the complex viscosity reaches a maximum. The table below illustrates dissolution temperatures determined according to this method using PVDF T-1 from Inner Mongolia 3F Wanhao Fluorochemical Co. Ltd. (PVDF T-1 has a particle size of about 330 to 380 nm and a weight average molecular weight of about 130,000 to 160,000 g/mol), in various solvents or solvent mixtures as listed.

| Solvent | Solvent %mass of organic medium | Cosolvent | Cosolvent % mass of organic medium | PVDF % mass of mixture | Dissolution Temp (°C) | Evaporation rate at Dissolution Temp (mg/min m²) |
|---|---|---|---|---|---|---|
| N-butylpyrrolidone | 100 | - | - | 45 | 48 | - |
| gamma-butyrolactone | 100 | - | - | 45 | 51 | 9.31 |
| Isophorone | 100 | - | - | 45 | 72 | 16.59 |
| Triacetin | 100 | - | - | 45 | 76 | 0.69 |
| Ethyl Acetoacetate | 100 | - | - | 45 | 76 | 37.76 |
| Triethylphosphate | 80 | Ethyl Acetoacetate | 20 | 45 | 46 | - |
| Triethylphosphate | 80 | Dowanol™ PM¹ | 20 | 45 | 58 | - |

¹ Propylene glycol methyl ether commercially available from The Dow Chemical Company.

The dissolution temperature of the primary fluoropolymer dispersed in the organic medium may be less than 77° C., such as less than 70° C., such as less than 65° C., such as less than 60° C., such as less than 55° C., such as less than 50° C. The dissolution temperature of the primary fluoropolymer dispersed in the organic medium may range from 30° C. to 77° C., such as from 30° C. to 70° C., such as 30° C. to 65° C., such as 30° C. to 60° C., such as 30° C. to 55° C., such as 30° C. to 50° C. The dissolution temperature may be measured according to the method discussed above.

The organic medium may comprise, for example, butyl pyrrolidone, trialkyl phosphate, triaryl phosphate, 1,2,3-triacetoxypropane, 3-methoxy-N,N-dimethylpropanamide, ethyl acetoacetate, gamma-butyrolactone, propylene glycol methyl ether, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, dipropylene glycol dimethyl ether, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), tripropylene glycol methyl ether, diethylene glycol ethyl ether acetate, or combinations thereof. The trialkyl phosphate may comprise, for example, trimethylphosphate, triethylphosphate, tripropylphosphate, tributylphosphate, or the like. The triaryl phosphate may comprise, for example, tri(o-tolyl)phosphate.

The organic medium may consist essentially of or consist of, for example, butyl pyrrolidone, trialkyl phosphate, 1,2,3-triacetoxypropane, 3-methoxy-N,N-dimethylpropanamide, ethyl acetoacetate, gamma-butyrolactone, cyclohexanone, propylene carbonate, dimethyl adipate, propylene glycol methyl ether acetate, dibasic ester (DBE), dibasic ester 5 (DBE-5), 4-hydroxy-4-methyl-2-pentanone (diacetone alcohol), propylene glycol diacetate, dimethyl phthalate, methyl isoamyl ketone, ethyl propionate, 1-ethoxy-2-propanol, saturated and unsaturated linear and cyclic ketones (commercially available as a mixture thereof as Eastman™ C-11 Ketone from Eastman Chemical Company), diisobutyl ketone, acetate esters (commercially available as Exxate™ 1000 from Hallstar), diethylene glycol ethyl ether acetate, or combinations thereof.

The organic medium may comprise a primary solvent and a co-solvent that form a homogenous continuous phase with the primary fluoropolymer as the dispersed phase. The primary solvent and co-solvent and relevant amounts thereof may be selected to provide a dispersion of the primary fluoropolymer in the organic medium at room temperature, i.e., about 23° C. Both the primary solvent and co-solvent may comprise organic solvent(s). The primary fluoropolymer may be soluble in the primary solvent at room temperature if used alone but use of the co-solvent with the primary solvent may allow for the primary fluoropolymer to be stably dispersed in the organic medium. The primary solvent may comprise, consist essentially of, or consist of, for example, butyl pyrrolidone, a trialkyl phosphate, 3-methoxy-N,N-dimethylpropanamide, 1,2,3-triacetoxypropane, or combinations thereof. The co-solvent may comprise, consist essentially of, or consist of, for example, ethyl acetoacetate, gamma-butyrolactone, and/or glycol ethers such as propylene glycol methyl ether, dipropylene glycol methyl ether, propylene glycol monopropyl ether, diethylene glycol monobutyl ether, ethylene glycol monohexyl ether, and the like. The primary solvent may be present in an amount of at least 50% by weight, such as at least 65% by weight, such as at least 75 by weight, and may be present in an amount of no more than 99% by weight, such as no more than 90% by weight, such as no more than 85% by weight, based on the total weight of the organic medium. The primary solvent may be present in an amount of 50% to 99% by weight, such as 65% to 90% by weight, such as 75% to 85% by weight, based on the total weight of the organic medium. The co-solvent may be present in an amount of at least 1% by weight, such as at least 10% by weight, such as at least 15% by weight, and may be present in an amount of no more than 50% by weight, such as no more than 35% by weight, such as no more than 25% by weight. The co-solvent may be present in an amount of 1% to 50% by weight, such as 10% to 35% by weight, such as 15% to 25% by weight, based on the total weight of the organic medium.

The organic medium may also have an evaporation rate greater than 80 g/min m², at 180° C., such as greater than 90 g/min m², at 180° C., such as greater than 100 g/min m², at 180° C.

The organic medium may be present in an amount of at least 10% by weight, such as at least 15% by weight, such as at least 20% by weight, such as at least 30% by weight, such as at least 35% by weight, such as at least 40% by weight, and may be present in an amount of no more than 80% by weight, such as no more than 70% by weight, such as no more than 60% by weight, such as no more than 50% by weight, such as no more than 45% by weight, such as no more than 45% by weight, such as no more than 40% by weight, such as no more than 35% by weight, such as no more than 29% by weight, such as no more than 25% by weight, based on the total weight of the binder composition and/or slurry composition. The organic medium may be present in an amount of such as 10% to 80% by weight, 20% to 70% by weight, such as 30% to 70% by weight, such as 35% to 60% by weight, such as 40% to 50% by weight, 15% to 60% by weight, 15% to 50% by weight, 15% to 45% by weight, 15% to 40% by weight, 15% to 35% by weight, 15% to 29% by weight, 15% to 25% by weight, based on the total weight of the binder composition and/or slurry composition.

The binder composition and/or slurry composition may be substantially free, essentially free, or completely free of N-Methyl-2-pyrrolidone (NMP). As used herein, the binder composition and/or slurry composition is “substantially free” of NMP if NMP is present, if at all, in an amount of less than 5% by weight, based on the total weight of the binder composition and/or slurry composition. As used herein, the binder composition and/or slurry composition is “essentially free” of NMP if NMP is present, if at all, in an amount of less than 0.3% by weight, based on the total weight of the binder composition and/or slurry composition. As used herein, the slurry composition is “completely free” of NMP if NMP is not present in the binder composition and/or slurry composition, i.e., 0.000% by weight, based on the total weight of the binder composition and/or slurry composition.

The binder composition and/or slurry composition may be substantially free, essentially free, or completely free of ketones such as methyl ethyl ketone, cyclohexanone, isophorone, acetophenone.

The binder composition and/or slurry composition may be substantially free, essentially free, or completely free of ethers such as the C₁ to C₄ alkyl ethers of ethylene or propylene glycol.

The binder composition and/or slurry composition may be substantially free, essentially free, or completely free of fluoroethylene, such as tetrafluoroethylene.

The primary fluoropolymer, secondary fluoropolymer, binder composition and/or slurry composition may be substantially free, essentially free, or completely free of fluorosurfactant.

The binder composition and/or slurry composition may be substantially free, essentially free, or completely free of siloxane.

The binder composition and/or slurry composition may optionally further comprise a dispersant. The dispersant may assist in dispersing the fluoropolymer, and/or, if present, the electrically conductive agent and/or the electrochemically active material in the organic medium. When present, the dispersant may be a component of the slurry composition binder. The dispersant may comprise at least one phase that is compatible with the primary fluoropolymer and/or other components of the slurry composition, such as the electrically conductive agent or electrochemically active material, if present, and may further comprise at least one phase that is compatible with the organic medium. The slurry composition may comprise one, two, three, four or more different dispersants, and each dispersant may assist in dispersing a different component of the slurry composition. The dispersant may comprise any material having phases compatible with each of the primary fluoropolymer, secondary fluoropolymer, and/or, if present, the electrically conductive agent or electrochemically active material, and the organic medium. As used herein, the term “compatible” means the ability of a material to form a blend with other materials that is and will remain substantially homogenous over time. The primary fluoropolymer and dispersant may not be bound by a covalent bond. For example, the dispersant may comprise a polymer comprising such phases. The polymer may be in the form of a block polymer, a random polymer, or a gradient polymer, wherein the phases of present in the different blocks of the polymer, are randomly included throughout the polymer, or are progressively more or less densely present along the polymer backbone, respectively. The dispersant may comprise any suitable polymer to serve this purpose. For example, the polymer may comprise addition polymers produced by polymerizing ethylenically unsaturated monomers, polyepoxide polymers, polyamide polymers, polyurethane polymers, polyurea polymers, polyether polymers, polyacid polymers, and polyester polymers, among others. The dispersant may also serve as an additional component of the binder composition or the binder of the slurry composition.

The dispersant may comprise functional groups. The functional groups may comprise, for example, active hydrogen functional groups, heterocyclic groups, and combinations thereof. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, carboxylic acid groups, and thiol groups. As used herein, the term “heterocyclic group” refers to a cyclic group containing at least two different elements in its ring such as a cyclic moiety having at least one atom in addition to carbon in the ring structure, such as, for example, oxygen, nitrogen or sulfur. Non-limiting examples of heterocylic groups include epoxides, aziridines, thioepoxides, lactams and lactones. In addition, when epoxide functional groups are present on the addition polymer, the epoxide functional groups on the dispersant may be post-reacted with a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the dispersant.

When acid functional groups are present, the dispersant may have a theoretical acid equivalent weight of at least 350 g/acid equivalent, such as at least 878 g/acid equivalent, such as at least 1,757 g/acid equivalent, and may be no more than 17,570 g/acid equivalent, such as no more than 12,000 g/acid equivalent, such as no more than 7,000 g/acid equivalent. The dispersant may have a theoretical acid equivalent weight of 350 to 17,570 g/acid equivalent, such as 878 to 12,000 g/acid equivalent, such as 1,757 to 7,000 g/acid equivalent.

As mentioned above, the dispersant may comprise an addition polymer. The addition polymer may be derived from, and comprise constitutional units comprising the residue of, one or more alpha, beta-ethylenically unsaturated monomers, such as those discussed below, and may be prepared by polymerizing a reaction mixture of such monomers. The mixture of monomers may comprise one or more active hydrogen group-containing ethylenically unsaturated monomers. The reaction mixture may also comprise ethylenically unsaturated monomers comprising a heterocyclic group. As used herein, an ethylenically unsaturated monomer comprising a heterocyclic group refers to a monomer having at least one alpha, beta ethylenic unsaturated group and at least cyclic moiety having at least one atom in addition to carbon in the ring structure, such as, for example, oxygen, nitrogen or sulfur. Non-limiting examples of ethylenically unsaturated monomers comprising a heterocyclic group include epoxy functional ethylenically unsaturated monomers, vinyl pyrrolidone and vinyl caprolactam, among others. The reaction mixture may additionally comprise other ethylenically unsaturated monomers such as alkyl esters of (meth)acrylic acid and others described below.

The addition polymer may comprise a (meth)acrylic polymer that comprises constitutional units comprising the residue of one or more (meth)acrylic monomers. The (meth)acrylic polymer may be prepared by polymerizing a reaction mixture of alpha, beta-ethylenically unsaturated monomers that comprise one or more (meth)acrylic monomers and optionally other ethylenically unsaturated monomers. As used herein, the term “(meth)acrylic monomer” refers to acrylic acid, methacrylic acid, and monomers derived therefrom, including alkyl esters of acrylic acid and methacrylic acid, and the like. As used herein, the term “(meth)acrylic polymer” refers to a polymer derived from or comprising constitutional units comprising the residue of one or more (meth)acrylic monomers. The mixture of monomers may comprise one or more active hydrogen group-containing (meth)acrylic monomers, ethylenically unsaturated monomers comprising a heterocyclic group, and other ethylenically unsaturated monomers. The (meth)acrylic polymer may also be prepared with an epoxy functional ethylenically unsaturated monomer such as glycidyl methacrylate in the reaction mixture, and epoxy functional groups on the resulting polymer may be post-reacted with a beta-hydroxy functional acid such as citric acid, tartaric acid, and/or 3-hydroxy-2-naphthoic acid to yield hydroxyl functional groups on the (meth)acrylic polymer.

The addition polymer may comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. The constitutional units comprising the residue of the alpha, beta-ethylenically unsaturated carboxylic acids may comprise at least 1% by weight, such as at least 2% by weight, such as at least 5% by weight, and may be no more than 50% by weight, such as no more than 20% by weight, such as no more than 10% by weight, such as no more than 5% by weight, based on the total weight of the addition polymer. The constitutional units comprising the residue of the alpha, beta-ethylenically unsaturated carboxylic acids may comprise 1% to 50% by weight, 2% to 50% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the alpha, beta-ethylenically unsaturated carboxylic acids in an amount of 1% to 50% by weight, 2% to 50% by weight, such as 2% to 20% by weight, such as 2% to 10% by weight, such as 2% to 5% by weight, such as 1% to 5% by weight, based on the total weight of polymerizable monomers used in the reaction mixture. The inclusion of constitutional units comprising the residue of an alpha, beta-ethylenically unsaturated carboxylic acids in the dispersant results in a dispersant comprising at least one carboxylic acid group which may assist in providing stability to the dispersion.

The addition polymer may comprise constitutional units comprising the residue of an alkyl ester of (meth)acrylic acid containing from 1 to 3 carbon atoms in the alkyl group. Non-limiting examples of alkyl esters of (meth)acrylic acid containing from 1 to 3 carbon atoms in the alkyl group include methyl (meth)acrylate and ethyl (meth)acrylate. The constitutional units comprising the residue of the alkyl esters of (meth)acrylic acid containing from 1 to 3 carbon atoms in the alkyl group may comprise at least 20% by weight, such as at least 30% by weight, such as at least 40% by weight, such as at least 45% by weight, such as at least 50% by weight, and may be no more than 98% by weight, such as no more than 96% by weight, such as no more than 90% by weight, such as no more than 80% by weight, such as no more than 75% by weight, based on the total weight of the addition polymer. The constitutional units comprising the residue of the alkyl esters of (meth)acrylic acid containing from 1 to 3 carbon atoms in the alkyl group may comprise 20% to 98% by weight, such as 30% to 96% by weight, such as 30% to 90% by weight, 40% to 90% by weight, such as 40% to 80% by weight, such as 45% to 75% by weight, based on the total weight of the addition polymer. The addition polymer may be derived from a reaction mixture comprising the alkyl esters of (meth)acrylic acid containing from 1 to 3 carbon atoms in the alkyl group in an amount of 20% to 98% by weight, such as 30% to 96% by weight, such as 30% to 90% by weight, 40% to 90% by weight, such as 40% to 80% by weight, such as 45% to 75% by weight, based on the total weight of polymerizable monomers used in the reaction mixture.

The addition polymer may comprise constitutional units comprising the residue of an alkyl ester of (meth)acrylic acid containing from 4 to 18 carbon atoms in the alkyl group. Non-limiting examples of alkyl esters of (meth)acrylic acid containing from 4 to 18 carbon atoms in the alkyl group include butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate and dodecyl (meth)acrylate. The constitutional units comprising the residue of the alkyl esters of (meth)acrylic acid containing from 4 to 18 carbon atoms in the alkyl group may comprise at least 2% by weight, such as at least 5% by weight, such as at least 10% by weight, such as at least 15% by weight, such as at least 20% by weight, and may be no more than 70% by weight, such as no more than 60% by weight, such as no more than 50% by weight, such as no more than 40% by weight, such as no more than 35% by weight, based on the total weight of the addition polymer. The constitutional units comprising the residue of the alkyl esters of (meth)acrylic acid containing from 4 to 18 carbon atoms in the alkyl group may comprise 2% to 70% by weight, such as 2% to 60% by weight, such as 5% to 50% by weight, 10% to 40% by weight, such as 15% to 35% by weight, based on the total weight of the addition polymer. The addition polymer may be derived from a reaction mixture comprising the alkyl esters of (meth)acrylic acid containing from 4 to 18 carbon atoms in the alkyl group in an amount of 2% to 70% by weight, such as 2% to 60% by weight, such as 5% to 50% by weight, 10% to 40% by weight, such as 15% to 35% by weight, based on the total weight of polymerizable monomers used in the reaction mixture.

The addition polymer may comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the hydroxyalkyl ester may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the hydroxyalkyl ester in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture. The inclusion of constitutional units comprising the residue of a hydroxyalkyl ester in the dispersant results in a dispersant comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides and blocked polyisocyanates, or with N-alkoxymethyl amide groups or blocked isocyanato groups present in the addition polymer when self-crosslinking monomers that have groups that are reactive with the hydroxyl groups are incorporated into the addition polymer.

The addition polymer may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers, such as glycidyl (meth)acrylate, vinyl pyrrolidone and vinyl caprolactam, among others. The constitutional units comprising the residue of the ethylenically unsaturated monomers comprising a heterocyclic group may comprise at least 0.5% by weight, such as at least 1% by weight, such as at least 5% by weight, such as at least 8% by weight, and may be no more than 99% by weight, such as no more than 50% by weight, such as no more than 40% by weight, such as no more than 30% by weight, such as no more than 27% by weight, based on the total weight of the addition polymer. The constitutional units comprising the residue of the ethylenically unsaturated monomers comprising a heterocyclic group may comprise 0.5% to 99% by weight, such as 0.5% to 50% by weight, such as 1% to 40% by weight, such as 5% to 30% by weight, 8% to 27% by weight, based on the total weight of the addition polymer. The addition polymer may be derived from a reaction mixture comprising the ethylenically unsaturated monomers comprising a heterocyclic group in an amount of 0.5% to 50% by weight, such as 1% to 40% by weight, such as 5% to 30% by weight, 8% to 27% by weight, based on the total weight of polymerizable monomers used in the reaction mixture.

As noted above, the addition polymer may comprise constitutional units comprising the residue of a self-crosslinking monomer, and the addition polymer may comprise a self-crosslinking addition polymer. As used herein, the term “self-crosslinking monomer” refers to monomers that incorporate functional groups that may react with other functional groups present on the dispersant to a crosslink between the dispersant or more than one dispersant. Non-limiting examples of self-crosslinking monomers include N-alkoxymethyl (meth)acrylamide monomers such as N-butoxymethyl (meth)acrylamide and N-isopropoxymethyl (meth)acrylamide, as well as self-crosslinking monomers containing blocked isocyanate groups, such as isocyanatoethyl (meth)acrylate in which the isocyanato group is reacted (“blocked”) with a compound that unblocks at curing temperature. Examples of suitable blocking agents include epsilon-caprolactone and methylethyl ketoxime. The constitutional units comprising the residue of the self-crosslinking monomer may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the self-crosslinking monomer may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the self-crosslinking monomer in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The addition polymer may comprise constitutional units comprising the residue of other alpha, beta-ethylenically unsaturated monomers. Non-limiting examples of other alpha, beta-ethylenically unsaturated monomers include vinyl aromatic compounds such as styrene, alpha-methyl styrene, alpha-chlorostyrene and vinyl toluene; organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the other alpha, beta-ethylenically unsaturated monomers may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the other alpha, beta-ethylenically unsaturated monomers in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The monomers and relative amounts may be selected such that the resulting addition polymer has a Tg of 100° C. or less, typically from -50° C. to +70° C., such as -50° C. to 0° C. A Tg that is below 0° C. may be desirable to ensure acceptable battery performance at low temperature.

The addition polymers may be prepared by conventional free radical initiated solution polymerization techniques in which the polymerizable monomers are dissolved in a second organic medium comprising a solvent or a mixture of solvents and polymerized in the presence of a free radical initiator until conversion is complete. The second organic medium used to prepare the addition polymer may be the same as the organic medium present in the binder composition and/or slurry composition such that the composition of the organic medium is unchanged by addition of the addition polymer solution. For example, the second organic medium may comprise the same primary solvent(s) and co-solvent(s) in the same ratios as the organic medium of the binder composition and/or slurry composition. Alternatively, the second organic medium used to prepare the addition polymer may be different and distinct from the organic medium of the binder composition and/or slurry composition. The second organic medium used to produce the addition polymer may comprise any suitable organic solvent or mixture of solvents, including those discussed above with respect to the organic medium, such as, for example, triethylphosphate.

Examples of free radical initiators are those which are soluble in the mixture of monomers such as azobisisobutyronitrile, azobis(alpha, gamma-methylvaleronitrile), tertiary-butyl perbenzoate, tertiary-butyl peracetate, benzoyl peroxide, ditertiary-butyl peroxide and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications. Tertiary-dodecyl mercaptan is preferred because it results in high conversion of monomer to polymeric product.

To prepare the addition polymer, the solvent may be first heated to reflux and the mixture of polymerizable monomers containing the free radical initiator may be added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

For use in the binder composition and/or slurry composition of the invention, the dispersants prepared as described above usually have a weight average molecular weight of about 5000 to 500,000 g/mol, such as 10,000 to 100,000 g/mol, and 25,000 to 50,000 g/mol.

The dispersant may be present in the binder in an amount of at least 2% by weight, such as at least 5% by weight, such as at least 10% by weight, based on the total weight of the binder solids. The dispersant may be present in the binder in an amount of no more than 20% by weight, such as no more than 15% by weight, such as no more than 10% by weight, such as no more than 5% by weight, based on the total weight of the binder solids. The dispersant may be present in the binder in amounts of 2% to 20% by weight, such as 2% to 15% by weight, such as 2% to 10% by weight, such as 2% to 5% by weight, such as 5% to 20% by weight, such as 5% to 15% by weight, such as 5% to 10% by weight, such as 10% to 20% by weight, such as 10% to 15% by weight, based on the total weight of the binder solids.

As noted above, the binder composition and/or slurry composition may optionally further comprise a separately added crosslinking agent for reaction with the dispersant. The crosslinking agent should be soluble or dispersible in the organic medium and be reactive with active hydrogen groups of the dispersant, such as the carboxylic acid groups and the hydroxyl groups, if present. Non-limiting examples of suitable crosslinking agents include aminoplast resins, blocked polyisocyanates and polyepoxides.

Examples of aminoplast resins for use as a crossslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactone and methylethyl ketoxime. At curing temperatures, the blocking agents unblock exposing isocyanate functionality that is reactive with the hydroxyl functionality associated with the (meth)acrylic polymer. Blocked polyisocyanate crosslinking agents are commercially available from Covestro as DESMODUR BL.

Carbodiimide crosslinking agents may be in monomeric or polymeric form, or a mixture thereof. Carbodiimide crosslinking agents refer to compounds having the following structure:

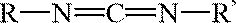

wherein R and R′ may each individually comprise an aliphatic, aromatic, alkylaromatic, carboxylic, or heterocyclic group. Examples of commercially available carbodiimide crosslinking agents include, for example, those sold under the trade name CARBODILITE available from Nisshinbo Chemical Inc., such as CARBODILITE V-02-L2, CARBODILITE SV-02, CARBODILITE E-02, CARBODILITE SW-12G, CARBODILITE V-10 and

### Carbodilite E-05

Examples of polyepoxide crosslinking agents are epoxy-containing (meth)acrylic polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

In addition to promoting the cross-linking of the dispersant, the crosslinking agents, including those associated with crosslinking monomers and separately added crosslinking agents, react with the hydrophilic groups, such as active hydrogen functional groups of the dispersant preventing these groups from absorbing moisture that could be problematic in a lithium ion battery.

The separately added crosslinker may be present in the binder in amounts of up to 15% by weight, such as 1% to 15% by weight, the % by weight being based on the total weight of the binder solids.

The binder composition and/or slurry composition may optionally further comprise an adhesion promoter. The adhesion promoter may comprise a polyvinylidene fluoride copolymer different than the primary fluoropolymer and secondary fluoropolymer described above, an acid-functional polyolefin, or a thermoplastic material.

The polyvinylidene fluoride copolymer adhesion promoter comprises constitutional units comprising the residue of vinylidene fluoride and at least one of (i) a (meth)acrylic acid; and/or (ii) a hydroxyalkyl (meth)acrylate. The (meth)acrylic acid may comprise acrylic acid, methacrylic acid, or combinations thereof. The hydroxyalkyl (meth)acrylate may comprise a C₁ to C₅ hydroxyalkyl (meth)acrylate, such as, for example, hydroxyethyl (meth)acrylate, 2-hydroxypropyl (meth)acrylate, 2-hydroxybutyl (meth)acrylate, or combinations thereof. A commercially available example of such an addition polymer includes SOLEF 5130, available from Solvay. The polyvinylidene fluoride copolymer may be dispersed or solubilized in the organic medium of the binder composition and/or slurry composition.

The acid-functional polyolefin adhesion promoter comprises an ethylene-(meth)acrylic acid copolymer, such as an ethylene-acrylic acid copolymer or an ethylene-methacrylic acid copolymer. The ethylene-acrylic acid copolymer may comprise constitutional units comprising 10% to 50% by weight acrylic acid, such as 15% to 30% by weight, such as 17% to 25% by weight, such as about 20% by weight, based on the total weight of the ethylene-acrylic acid copolymer, and 50% to 90% by weight ethylene, such as 70% to 85% by weight, such as 75% to 83% by weight, such as 80% by weight, based on the total weight of the ethylene-acrylic acid copolymer. A commercially available example of such an addition polymer includes PRIMACOR 5980i, available from the Dow Chemical Company.

The adhesion promoter may be present in the binder composition and/or slurry composition in an amount of 10% to 60% by weight, 20% to 60% by weight, such as 30% to 60% by weight, such as 10% to 50% by weight, such as 15% to 40% by weight, such as 20% to 30% by weight, such as 35% by weight, based on the total weight of the binder solids.

The coating film produced from the binder composition and/or slurry composition comprising an adhesion promoter may possess improved adhesion to the current collector compared to a coating film produced from a binder composition and/or slurry composition that does not include the adhesion promoter. For example, the use of the coating film resulting from the binder composition and/or slurry composition comprising an adhesion promoter may improve adhesion by at least 50%, such as at least 100%, such as at least 200%, such as at least 300%, such as at least 400%, compared to a coating film produced from a binder composition and/or slurry composition that does not include the adhesion promoter.

The binder composition typically has a resin solids content of from 30% to 80% by weight, such as 40% to 70% by weight, based on the total weight of the binder composition. As used herein, the term “resin solids” may be used synonymously with “binder solids” and include the primary fluoropolymer, secondary fluoropolymer, and, if present, dispersant, adhesion promoter, and separately added crosslinking agent. As used herein, the term “binder composition” refers to a dispersion of the binder solids in the organic medium. The primary fluoropolymer may be present in the binder composition and/or slurry composition in amounts of 30% to 98% by weight, such as 30% to 95% by weight, such as 30% to 90% by weight, such as 30% to 85% by weight, such as 30% to 70% by weight, such as 30% to 60% by weight, such as 30% to 50% by weight, such as 40% to 98% by weight, such as 40% to 95% by weight, such as 40% to 90% by weight, such as 40% to 85% by weight, such as 40% to 70% by weight, such as 40% to 60% by weight, such as 40% to 50% by weight, such as 50% to 98% by weight, such as 50% to 95% by weight, such as 50% to 90% by weight, such as 50% to 85% by weight, such as 50% to 70% by weight, such as 50% to 60% by weight, such as 65% to 98% by weight, such as 65% to 95% by weight, such as 65% to 90% by weight, such as 65% to 85% by weight, such as 65% to 70% by weight, such as 70% to 98% by weight, such as 70% to 95% by weight, such as 70% to 90% by weight, such as 70% to 85% by weight, such as 80% to 98% by weight, such as 80% to 95% by weight, such as 80% to 90% by weight, such as 80% to 85% by weight, such as 85% to 98% by weight, such as 85% to 95% by weight, such as 85% to 90% by weight, such as 90% to 98% by weight, such as 90% to 95% by weight, such as 95% to 98% by weight,; the secondary fluoropolymer may be present in amounts of 0.1% to 35% by weight, such as 0.1% to 25% by weight, such as 0.1% to 20% by weight, such as 0.1% to 15% by weight, such as 0.1% to 10% by weight, such as 0.1% to 7.5% by weight, such as 0.1% to 5% by weight, such as 0.1% to 3% by weight, such as 0.1% to 2% by weight, such as 0.1% to 1% by weight, such as 0.5% to 35% by weight, such as 0.5% to 25% by weight, such as 0.5% to 20% by weight, such as 0.5% to 15% by weight, such as 0.5% to 10% by weight, such as 0.5% to 7.5% by weight, such as 0.5% to 5% by weight, such as 0.5% to 3% by weight, such as 0.5% to 2% by weight, such as 0.5% to 1% by weight, such as 1% to 35% by weight, such as 1% to 25% by weight, such as 1% to 20% by weight, such as 1% to 15% by weight, such as 1% to 10% by weight, such as 1% to 7.5% by weight, such as 1% to 5% by weight, such as 1% to 3% by weight, such as 1% to 2% by weight, such as 2% to 35% by weight, such as 2% to 25% by weight, such as 2% to 20% by weight, such as 2% to 15% by weight, such as 2% to 10% by weight, such as 2% to 7.5% by weight, such as 2% to 5% by weight, such as 2% to 3% by weight, such as such as 5% to 35% by weight, such as 5% to 25% by weight, such as 5% to 20% by weight, such as 5% to 15% by weight, such as 5% to 10% by weight, such as 5% to 7.5% by weight, such as 7.5% to 35% by weight, such as 7.5% to 25% by weight, such as 7.5% to 20% by weight, such as 7.5% to 15% by weight, such as 7.5% to 10% by weight, such as 10% to 35% by weight, such as 10% to 25% by weight, such as 15% to 35% by weight, such as 15% to 25% by weight, such as 20% to 35% by weight, such as 20% to 25% by weight, such as 25% to 35% by weight, such as 30% to 35% by weight; the dispersant may optionally be present in amounts of 2% to 20% by weight, such as 2% to 15% by weight, such as 2% to 10% by weight, such as 2% to 5% by weight, such as 5% to 20% by weight, such as 5% to 15% by weight, such as 5% to 10% by weight, such as 10% to 20% by weight, such as 10% to 15% by weight; the adhesion promoter may optionally be present in the binder composition and/or slurry composition in an amount of 10% to 60% by weight, 20% to 60% by weight, such as 30% to 60% by weight, such as 10% to 50% by weight, such as 15% to 40% by weight, such as 20% to 30% by weight, such as 35% to 35% by weight; and the separately added crosslinker may optionally be present in amounts of up to 15% by weight, such as 1% to 15% by weight, the % by weight being based on the total weight of the binder solids. The organic medium may be present in the binder composition and/or slurry composition in amounts of 10% to 70% by weight, such as 10% to 65% by weight, such as 15% to 60% by weight, such as 15% to 40% by weight, such as 30% to 60% by weight, based on total weight of the binder composition and/or slurry composition.

The binder solids may be present in the slurry composition in amounts of 0.1% to 20% by weight, such as 1% to 10% by weight, such as 0.5% to 5.5%, such as 5% to 10% by weight, such as 1% 4% by weight, such as 1% to 3% by weight, such as 1% to 2% by weight, based on the total solids weight of the slurry.

The primary fluoropolymer may be present in the slurry composition in an amount of at least 0.1% by weight, such as at least 1% by weight, such as at least 1.3% by weight, such as 1.9% by weight, based on the total solids weight of the slurry composition. The primary fluoropolymer may be present in the slurry composition in an amount of no more than 10% by weight, such as no more than 6% by weight, such as no more than 4.5% by weight, such as no more than 2.9% by weight, based on the total solids weight of the slurry composition. The primary fluoropolymer may be present in the slurry composition in an of 0.1% to 10% by weight, such as 0.1% to 6% by weight, such as 0.1% to 4.5% by weight, such as 0.1% to 2.9% by weight, such as 1% to 10% by weight, such as 1% to 6% by weight, such as 1% to 4.5% by weight, such as 1% to 2.9% by weight, such as 1.3% to 10% by weight, such as 1.3% to 6% by weight, such as 1.3% to 4.5% by weight, such as 1.3% to 2.9% by weight, such as 1.9% to 10% by weight, such as 1.9% to 6% by weight, such as 1.9% to 4.5% by weight, such as 1.9% to 2.9% by weight, based on the total solids weight of the slurry composition.

The secondary fluoropolymer may be present in the slurry composition in an amount of at least 0.01% by weight, such as at least 0.1% by weight, such as at least 0.13% by weight, such as 0.19% by weight, based on the total solids weight of the slurry composition. The secondary fluoropolymer may be present in the slurry composition in an amount of no more than 1% by weight, such as no more than 0.6% by weight, such as no more than 0.45% by weight, such as no more than 0.29% by weight, based on the total solids weight of the slurry composition. The secondary fluoropolymer may be present in the slurry composition in an of 0.01% to 1% by weight, such as 0.01% to 0.6% by weight, such as 0.01% to 0.45% by weight, such as 0.01% to 0.29% by weight, such as 0.1% to 1% by weight, such as 0.1% to 0.6% by weight, such as 0.1% to 0.45% by weight, such as 0.1% to 0.29% by weight, such as 0.13% to 1% by weight, such as 0.13% to 0.6% by weight, such as 0.13% to 0.45% by weight, such as 0.13% to 0.29% by weight, such as 0.19% to 1% by weight, such as 0.19% to 0.6% by weight, such as 0.19% to 0.45% by weight, such as 0.19% to 0.29% by weight, based on the total solids weight of the slurry composition.

The dispersant, if present, may be present in the slurry composition in an amount of 0.1% to 10% by weight, such as 1% to 6% by weight, such as 1.3% to 4.5% by weight, such as 1.9% to 2.9% by weight, based on the total solids weight of the slurry composition.

The separately added crosslinking agent may be present in the slurry composition in an amount of 0.001% to 5% by weight, such as 0.002% to 2% by weight, such as 0.002 to 1% by weight, such as 0.005 to 0.5% by weight, such as 0.005 to 0.3% by weight, such as 0.1% to 5% by weight, based on the total solids weight of the slurry composition.

The slurry composition may optionally further comprise an electrochemically active material. The material constituting the electrochemically active material contained in the slurry is not particularly limited and a suitable material can be selected according to the type of an electrical storage device of interest.

The electrochemically active material may comprise a material for use as an active material for a positive electrode. The electrochemically active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, and combinations thereof. Non-limiting examples of materials capable of lithium conversion include sulfur, LiO₂, FeF₂ and FeF₃, Si, aluminum, tin, SnCo, Fe₃O4, and combinations thereof.

The electrochemically active material may comprise a material for use as an active material for a negative electrode. The electrochemically active material may comprise graphite, lithium titanate, silicon compounds, tin, tin compounds, sulfur, sulfur compounds, or a combination thereof.

The electrochemically active material may be present in the slurry in amounts of 45% to 99% by weight, such as 50% to 99% by weight, such as 55% to 99% by weight, such as 60% to 99% by weight, such as 65% to 99% by weight, such as 85% to 99% by weight, such as 95% to 99% by weight, such as 97% to 99% by weight, such as 98% to 99% by weight, such as 55 to 98% by weight, such as 65% to 98% by weight, such as 70% to 98% by weight, such as 80% to 98% by weight, such as 90% to 98% by weight, such as 91% to 98% by weight, such as 91% to 95% by weight, such as 94% to 98% by weight, such as 95% to 98% by weight, such as 96% to 98% by weight, based on the total solids weight of the slurry.

The slurry composition of the present invention may optionally further comprise an electrically conductive agent. Non-limiting examples of electrically conductive agents include carbonaceous materials such as, activated carbon, carbon black such as acetylene black and furnace black, graphite, graphene, carbon nanotubes, carbon fibers, fullerene, and combinations thereof. The electrically conductive material may also comprise any active carbon that has a high-surface area, such as a BET surface area of greater than 100 m²/g. As used herein, the term “BET surface area” refers to a specific surface area determined by nitrogen adsorption according to the ASTM D 3663-78 standard based on the Brunauer-Emmett-Teller method described in the periodical “The Journal of the American Chemical Society”, 60, 309 (1938). In some examples, the conductive carbon can have a BET surface area of 100 m²/g to 1,000 m²/g, such as 150 m²/g to 600 m²/g, such as 100 m²/g to 400 m²/g, such as 200 m²/g to 400 m²/g. In some examples, the conductive carbon can have a BET surface area of about 200 m²/g. A suitable conductive carbon material is LITX 200 commercially available from Cabot Corporation. The conductive carbon material can be present in the slurry in amounts of 2 to 20, typically 5 to 10 percent by weight, based on total solids weight of the slurry.

The electrically conductive agent may be present in the slurry in amounts of 1% to 20% by weight, such as 5% to 10% by weight, based on the total solids weight of the slurry.

The slurry composition may be in the form of an electrode slurry composition comprising the binder, electrochemically active material and electrically conductive material, each as described above. The electrode slurry may comprise such materials present in the slurry composition in the amounts described above. For example, the electrode slurry composition may comprise the electrochemically active material present in amounts of 45% to 95% by weight, such as 70% to 98% by weight; the binder solids from the binder composition present in amounts of 1% to 20% by weight, such as 1% to 10% by weight, such as 5% to 10% percent by weight; and the electrically conductive agent present in amounts of 1% to 20% by weight, such as 5% to 10% by weight, the percentages by weight based on the total solids weight of the electrode slurry composition.

The electrode slurry composition comprising the organic medium, electrochemically active material, electrically conductive material, binder dispersion (which may include a separately added crosslinking agent), additional organic medium, if needed, and optional ingredients, may be prepared by combining the ingredients to form the slurry. These substances can be mixed together by agitation with a known means such as a stirrer, bead mill or high-pressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meet this condition include ball mill, sand mill, pigment disperser, grinding machine, extruder, rotor stator, pug mill, ultrasonic disperser, homogenizer, planetary mixer, Hobart mixer, and combinations thereof.

The slurry composition may have a solids content of at least 30% by weight, such as at least 40% by weight, such as at least 50% by weight, such as at least 55%, such as at least 60%, such as at least 65%, such as at least 71%, such as at least 75%, and may be no more than 90% by weight, such as no more than 85% by weight, such as no more than 75% by weight, the % by weight based on the total weight of the slurry composition. The slurry composition may have a solids content of 30% to 90% by weight, such as 40% to 85% by weight, such as 50% to 85% by weight, such as 55% to 85% by weight, such as 60% to 85% by weight, such as 65% to 85% by weight, such as 71% to 85% by weight, such as 75% to 85% by weight, based on the total weight of the slurry composition.

The use of the organic medium and binder of the present invention may result in a more stable slurry composition than those previously employed. For example, the slurry composition may maintain shelf-life stability for a longer period of time than previous slurry compositions that used N-methyl pyrrolidone (NMP). The improved shelf-life stability may be determined by measuring the viscosity of the slurry composition periodically over a period of time. For example, equivalent slurry compositions may be prepared with one using the organic medium of the present invention and a second using NMP.

The present invention is also directed to an electrode comprising an electrical current collector; and a film formed on the electrical current collector, wherein the film comprises: (1) an electrochemically active material; and (2) a binder comprising: (a) a primary fluoropolymer; and (b) a secondary fluoropolymer different from the primary fluoropolymer, wherein the secondary fluoropolymer comprises at least one perfluoropolyether segment, at least one non-fluorinated segment, and a linking group that links the perfluoropolyether segment and the non-fluorinated segment. The binder may comprise and be derived from any of the binder compositions described herein. The film may be deposited from the electrode slurry composition described above. The electrode may be a positive electrode or a negative electrode and may be manufactured by applying the above-described slurry composition to the surface of the current collector to form a coating film, and subsequently drying and/or curing the coating film. The coating film may have a thickness of at least 1 micron, such as 1 to 500 microns (µm), such as 1 to 150 µm, such as 25 to 150 µm, such as 30 to 125 µm. The coating film may comprise a crosslinked coating. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

In addition, the current collector may be pretreated with a pretreatment composition prior to depositing the slurry composition. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The method of applying the slurry composition to the current collector is not particularly limited. The slurry composition may be applied by doctor blade coating, dip coating, reverse roll coating, direct roll coating, gravure coating, extrusion coating, immersion or brushing. Although the application quantity of the slurry composition is not particularly limited, the thickness of the coating formed after the organic medium is removed may be 25 to 150 microns (µm), such as 30 to 125 µm.

Drying and/or crosslinking the coating film after application, if applicable, can be done, for example, by heating at elevated temperature, such as at least 50° C., such as at least 60° C., such as in the range of from 50-145° C., such as 60-120° C., such as 65-110° C. The time of heating will depend somewhat on the temperature. Generally, higher temperatures require less time for curing. Typically, curing times are for at least 5 minutes, such as 5 to 60 minutes. The temperature and time should be sufficient such that the dispersant in the cured film is crosslinked (if applicable), that is, covalent bonds are formed between co-reactive groups on the dispersant polymer chain, such as carboxylic acid groups and hydroxyl groups and the N-methylol and/or the N-methylol ether groups of an aminoplast, isocyanato groups of a blocked polyisocyanate crosslinking agent, or in the case of a self-curing dispersant, the N-alkoxymethyl amide groups or blocked isocyanato groups. The extent of cure or crosslinking may be measured as resistance to solvents such as methyl ethyl ketone (MEK). The test is performed as described in ASTM D-540293. The number of double rubs, one back and forth motion, is reported. This test is often referred to as “MEK Resistance”. Accordingly, the dispersant and crosslinking agent (inclusive of self-curing dispersants and dispersants with separately added crosslinking agents) is isolated from the binder composition, deposited as a film and heated for the temperature and time that the binder film is heated. The film is then measured for MEK Resistance with the number of double rubs reported. Accordingly, a crosslinked dispersant will have an MEK Resistance of at least 50 double rubs, such as at least 75 double rubs. Also, the crosslinked dispersant may be substantially solvent resistant to the solvents of the electrolyte mentioned below. Other methods of drying the coating film include ambient temperature drying, microwave drying and infrared drying, and other methods of curing the coating film include e-beam curing and UV curing.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

The present invention is also directed to an electrical storage device. An electrical storage device according to the present invention can be manufactured by using the above electrodes prepared from the electrode slurry composition of the present invention. The electrical storage device comprises an electrode, a counter electrode and an electrolyte. The electrode, counter-electrode or both may comprise the electrode of the present invention, as long as one electrode is a positive electrode and one electrode is a negative electrode. Electrical storage devices according to the present invention include a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB₁₀C₁₀, LiA1C14, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include carbonate compounds such as propylene carbonate, ethylene carbonate, butylene carbonate, dimethyl carbonate, methyl ethyl carbonate and diethyl carbonate; lactone compounds such as y-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography (GPC) using Waters 2695 separation module with a Waters 410 differential refractometer (RI detector), linear polystyrene standards having molecular weights of from 580 Da to 365,000 Da, dimethylformamide (DMF) with 0.05 M lithium bromide (LiBr) as the eluent at a flow rate of 0.5 mL/min, and one Shodex Asahipak GF-510 HQ column (300 x 7.5 mm, 5 µm) for separation.

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the respective composition.

As used herein, unless otherwise defined, the term essentially free means that the component is present, if at all, in an amount of less than 1% by weight, based on the total weight of the respective composition.

As used herein, unless otherwise defined, the term completely free means that the component is not present in the slurry composition, i.e., 0.00% by weight, based on the total weight of the respective composition.

As used herein, the term “total solids” refers to the non-volatile components of the slurry composition of the present invention and specifically excludes the organic medium.

As used herein, the term “consists essentially of” includes the recited material or steps and those that do not materially affect the basic and novel characteristics of the claimed invention.

As used herein, the term “consists of” excludes any element, step or ingredient not recited.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” electrochemically active material, “a” fluoropolymer, “a” dispersant, and “an” electrically conductive agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. Although various embodiments of the invention have been described in terms of “comprising”, embodiments consisting essentially of or consisting of are also within the scope of the present invention.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1: Preparation of a Di-hydroxyl Functional Secondary Fluoropolymer

A secondary fluoropolymer was prepared from the following charges:

| Ingredients | Parts by weight |
|---|---|
| Charge #1 | |
| TMXDI¹ | 16.9 |
| Fluorolink EI0H² | 24.8 |
| Triethyl phosphate³ | 208.3 |
| Charge #2 | |
| DBTDL⁴ | 0.01 |

¹ TMXDI is Tetramethylxylene diisocyanate and commercially available from Allenex.
² Fluorolink® E10H is a di-hydroxyl functional perfluoropolyether commercially available from Solvay.
³ Triethyl phosphate is commercially available from Aceto Corp.
⁴ DBTDL is Dibutyl tin dilaurate and commercially available from Arkema Inc.

Charge 1 was added to a 1000 mL, 4-necked flask equipped with a motor driven stainless steel stir blade, a water-cooled condenser, a nitrogen blanket, and a heating mantle with a thermometer connected through a temperature feedback control device. The reaction mixture was heated to 75° C. At 75° C., charge 2 was added into reaction mixture dropwise. After addition, the reaction mixture was held at 75° C. until IR spectroscopy showed the absence of the characteristic NCO band (2269 cm⁻¹) using the Thermo Scientific Nicolet iS5 FT-IR. The reaction product was poured out at 60° C.

### Example 2: Preparation of a Secondary Fluoropolymer

A secondary fluoropolymer was prepared from the following charges

| Ingredients | Parts by weight |
|---|---|
| Charge #1 | |
| TMXDI¹ | 91.6 |
| Triethyl phosphate³ | 133.69 |
| Charge #2 | |
| DBTDL⁴ | 0.1 |
| Charge #3 | |
| Fluorolink E10H² | 281.3 |
| Charge #4 | |
| Butanol | 32.8 |

¹ TMXDI is Tetramethylxylene diisocyanate and commercially available from Allenex.
² Fluorolink® E10H is commercially available from Solvay.
³ Triethyl phosphate is commercially available from Aceto Corp.
⁴ DBTDL is Dibutyl tin dilaurate and commercially available from Arkema Inc.

Charge 1 and 2 were added to a 1000 mL, 4-necked flask equipped with a motor driven stainless steel stir blade, a water-cooled condenser, a nitrogen blanket, and a heating mantle with a thermometer connected through a temperature feedback control device. The reaction mixture was heated to 75° C. At 75° C., charge 3 was added into reaction mixture dropwise over 30 minutes. After addition, the reaction mixture was held at 75° C. until isocyanate equivalent was stalled (NCO EQ WT=1145.30). Then charge 4 was added into reaction mixture over 1 hour. The reaction mixture was held at 95° C. until IR spectroscopy showed the absence of the characteristic NCO band (2269 cm-1) using the Thermo Scientific Nicolet iS5 FT-IR. The reaction product was poured out at 70° C.

### Preparation of Dispersants 1 and 2

Preparation of Dispersant 1: A (meth)acrylic polymer dispersant was prepared as follows using the ingredients in the table below:

| | Ingredient | Amount (gram) |
|---|---|---|
| Charge 1 | Methylether of propylene glycol | 658.0 |
| Charge 2 (premixed) | Methyl methacrylate | 784.8 |
| | 2-ethyl hexyl acrylate | 336.3 |
| | Ethyl acrylate | 435.9 |
| | Hydroxyl ethyl acrylate | 33.2 |
| | Methacrylic acid | 33.15 |
| Charge 3 (premixed) | Tertiary amyl peroxy 2-ethyl hexyl carbonate | 33.8 |
| | Methylether of propylene glycol | 169.6 |
| Charge 4 (premixed) | Tertiary amyl peroxy 2-ethyl hexyl carbonate | 11.9 |
| | methylether of propylene glycol | 169.6 |
| Charge 5 | methylether of propylene glycol | 584.6 |

To a suitable reaction vessel equipped with a stirrer, reflux condenser, thermometer, heating mantle and nitrogen inlet, Charge 1 was added at ambient temperatures. The temperature was then increased to reflux (^{~}150° C.), at which time the catalyst premix of Charge 3 was added over 185 minutes. Five (5) minutes after the start of Charge 3, Charge 2 was added over 180 minutes. Upon completion of Charges 2 and 3, Charge 4 was added over 60 minutes, followed by a hold for additional 60 minutes at reflux (^{~}150° C.). Thereafter the reaction temperature was cooled to 40° C. and Charge 5 was added with a subsequent 30 minute hold period. The polymeric product thus formed had a theoretical solids of 52%.

Preparation of Dispersant 2: A (meth)acrylic copolymer dispersant was prepared as follows: To a four neck round bottom flask, 375.4 grams of triethylphosphate (TEP) was added and the flask was set up with a mechanical stir blade, thermocouple, and reflux condenser. The flask containing TEP solvent was heated to a set point of 120° C. under a nitrogen atmosphere. A monomer solution containing 228.2 grams of methyl methacrylate (MMA), 215.7 grams of 2- ethylhexyl acrylate (EHA), 58.4 grams of ethyl acrylate (EA), 58.4 grams of N-vinyl pyrrolidone (NVP), 11.5 grams of hydroxy ethyl acrylate (HEA), and 11.5 grams of methacrylic acid (MAA) was thoroughly mixed in a separate container. A solution of 12.9 grams of tert-amylperoxy 2-ethylhexyl carbonate (Trigonox 131, available from AkzoNobel) and 61.1 grams of TEP was prepared and added into the flask over 185 minutes. Five minutes after the initiator solution started, addition of the monomer solution was started and the monomer solution was added to the flask over 180 minutes. After both initiator and monomer feeds were complete, the monomer addition funnel was rinsed with 14.4 grams of TEP. Then another solution of 4.3 grams of Trigonox 131 and 61.1 grams of TEP was added over 60 min. After this second initiator feed was complete, the initiator addition funnel was rinsed with 57.9 grams of TEP. The reaction mixture was then held at 120° C. for 60 minutes. After the 60-minute hold, the reaction mixture was cooled and poured into a suitable container. The final measured solids content of the reaction product was determined to be 51.02 weight %.

### Preparation of Binder Compositions

Binder compositions for Examples 3-7 were prepared using the ingredients in the table below as follows: For each composition, to a plastic cup was added triethyl phosphate (charge 1), ethyl acetoacetate (charge 2), (meth)acrylic copolymer dispersant 1 (charge 3), (meth)acrylic copolymer dispersant 2 (charge 4), the secondary fluoropolymer of Example 1 (charge 5), and/or the secondary fluoropolymer of Example 2 (charge 6). The mixture was stirred with a dispersing blade until the dispersants and secondary fluoropolymer were fully incorporated into the solvent. Then, polyvinylidene fluoride polymer (charge 7, PVDF T-1 from Inner Mongolia 3F Wanhao Fluorochemical Co., Ltd.) was slowly added over 30 to 60 minutes while stirring with a dispersing blade until the PVDF was completely incorporated into the mixture. The measured total non-volatiles content of this slurry was 45.00 weight %.

| Charge | Ingredient | Comp. Ex. 3 (g) | Ex. 4 (g) | Ex. 5 (g) | Ex. 6 (g) | Ex. 7(g) |
|---|---|---|---|---|---|---|
| 1 | Triethyl phosphate | 56.49 | 63.5 | 59.9 | 64.52 | 61.95 |
| 2 | Ethyl acetoacetate | 16.5 | 17.83 | 16.5 | 17.83 | 16.5 |
| 3 | Dispersant 1 | 13.26 | 6.63 | 0 | 6.63 | 0 |
| 4 | Dispersant 2 | 6.7 | 6.7 | 6.7 | 6.7 | 6.7 |
| 5 | Secondary Fluoropolymer of Example 1 | 0 | 0 | 0 | 3.91 | 7.81 |
| 6 | Secondary Fluoropolymer of Example 2 | 0 | 4.93 | 9.85 | 0 | 0 |
| 7 | PVDF T-1 | 57.04 | 57.04 | 57.04 | 57.04 | 57.04 |

Binder films were prepared as follows: To an aluminum foil pan, 2 grams of each binder composition was added. The pan was then put into an oven with the temperature set to 120° C. and were baked for at least 3 hours to dry.

### Electrolyte Soaking

The binder films were then tested for resistance to electrolyte. The electrolyte soaking study was performed as follows: Ethylene carbonate, propylene carbonate, and dimethyl carbonate were mixed under ratio of 3:3:7 to prepare an electrolyte mixture. The binder film was cut into 3 mm pellets using a stainless steel blade to increase the surface area that contacts the electrolyte. 1 g of binder pellets were weighed using an analytical balance and added to 15 grams of the electrolyte mixture in a 10 mL glass vial. A lid sealed the vial and it was stored under ambient temperature for 1 month.

After a month, the binder pellets were filtered from the electrolyte mixture and dried in oven at 120° C. for at least 3 hours. The binder pellets were then weighed using an analytical balance and compared to the original weight of the pellets prior to addition to the vial to determine the weight loss from soaking in the electrolyte. The weight loss percentage was determined by subtracting the weight of the pellets after soak from the weight of the pellets before soak, dividing that number by the weight of the pellets before soaking, and multiplying by 100 to determine the weight loss percentage. The weight loss percentage for each of Examples 3-7 are provided in the table below.

| | Comp. Ex. 3 | Ex. 4 | Ex. 5 | Ex. 6 | Ex. 7 |
|---|---|---|---|---|---|
| Weight loss after soaking (%) | 18.20% | 11.90% | 11.20% | 9.70% | 0.00% |

As shown in the table above, inclusion of the secondary fluoropolymer of the present invention resulted in a reduced weight loss percentage for each of Examples 4-7 when compared to comparative Example 3 that does not include the secondary fluoropolymer.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A binder composition comprising:
(a) a primary fluoropolymer; and
(b) a secondary fluoropolymer different from the primary fluoropolymer,
wherein the secondary fluoropolymer comprises at least one perfluoropolyether segment, at least one non-fluorinated segment, and a linking group that links the perfluoropolyether segment and the non-fluorinated segment.

2. The binder composition of claim 1, wherein the linking group comprises a urethane linking group linking the perfluoropolyether segment and the non-fluorinated segment.

3. The binder composition of claim 1, wherein the secondary fluoropolymer comprises the residue of a hydroxyl-functional perfluoropolyether and the residue of an isocyanato-functional non-fluorinated compound.

4. The binder composition of claim 1, wherein the secondary fluoropolymer comprises at least one active hydrogen functional group.

5. The binder composition of claim 1, wherein the secondary fluoropolymer comprises at least one hydroxyl functional group.

6. The binder composition of claim 1, wherein the secondary polymer further comprises a polyfluorinated polyether segment.

7-8. (canceled)

9. The binder composition of claim 1, wherein the secondary fluoropolymer comprises the structure: 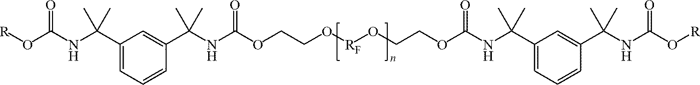
wherein each R independently comprises an alkyl, aryl, cycloalkyl, or cycloaryl group, n is an integer from 1 to 500, and each R_{F} is independently (CF₂)ₘ wherein m is 1 or 2.

10. (canceled)

11. The binder composition of claim 1, wherein the primary fluoropolymer comprises a polyvinylidene fluoride polymer.

12. The binder composition of claim 1, further comprising a dispersant.

13-15. (canceled)

16. The binder composition of claim 12, wherein the dispersant is self-crosslinking.

17. The binder composition of claim 1, wherein the slurry composition further comprises a cross-linker.

18. The binder composition of claim 1, further comprising a liquid medium.

19. (canceled)

20. The binder composition of claim 18, wherein the liquid medium comprises an organic medium.

21-22. (canceled)

23. The binder composition of claim 1, further comprising an adhesion promoter.

24. A slurry composition comprising:
the binder composition of claim 1;
an electrochemically active material; and
a liquid medium.

25-33. (canceled)

34. A slurry composition comprising:
the binder composition of claim 1;
an electrically conductive agent; and
a liquid medium.

35. An electrode comprising an electrical current collector; and a film formed on the electrical current collector, wherein the film comprises:
(1) an electrochemically active material; and
(2) a binder comprising:
(a) a primary fluoropolymer; and
(b) a secondary fluoropolymer different from the primary fluoropolymer, wherein the secondary fluoropolymer comprises at least one perfluoropolyether segment, at least one non-fluorinated segment, and a linking group that links the perfluoropolyether segment and the non-fluorinated segment.

36. The electrode of claim 35, wherein the film is deposited from the a slurry composition comprising:
a binder composition comprising:
(A) a primary fluoropolymer; and
(B) a secondary fluoropolymer different from the primary fluoropolymer, wherein the secondary fluoropolymer comprises at least one perfluoropolyether segment, at least one non-fluorinated segment, and a linking group that links the perfluoropolyether segment and the non-fluorinated segment;
an electrochemically active material; and
a liquid medium.

37-40. (canceled)

41. The electrode of claim 35, wherein the electrical current collector is pretreated with a pretreatment composition.

42. An electrical storage device comprising:
(a) the electrode of any of claim 35;
(b) a counter electrode; and
(c) an electrolyte.

43-49. (canceled)
